(19) United States
(12) Patent Application Publication
(10) Pub. No.: US 2020/0287204 A1
(43) Pub. Date: Sep. 10, 2020

(54) NEGATIVE ELECTRODE ACTIVE SUBSTANCE MATERIAL AND ELECTRICITY STORAGE DEVICE

(71) Applicant: TOYOTA JIDOSHA KABUSHIKI KAISHA, Toyota-shi (JP)

(72) Inventors: Hiroyuki KAWAURA, Nagakute-shi (JP); Yasuhito KONDO, Nagakute-shi (JP); Yoshinari MAKIMURA, Nagakute-shi (JP); Tetsuya WASEDA, Susono-shi (JP); Masaki ADACHI, Mishima-shi (JP); Jun YOSHIDA, Mishima-shi (JP); Hiroyuki YAMAGUCHI, Susono-shi (JP)

(21) Appl. No.: 16/804,893

(22) Filed: Feb. 28, 2020

(30) Foreign Application Priority Data
Mar. 5, 2019 (JP) 2019-039928

(51) Int. Cl. H01M 4/36; H01M 4/38; H01M 4/58; H01G 11/30

(52) U.S. Cl. CPC H01M 4/364; H01M 4/386; H01M 2004/027; H01G 11/30; H01M 4/58

(57) ABSTRACT

A negative electrode active substance material used for an electricity storage device of the present disclosure includes a silicon phase and a silicide phase represented by a basic composition formula MSi₂, where M is one or more of Cr, Ti, Zr, Nb, Mo, and Hf. The negative electrode active substance material may have a structure in which the silicide phase is dispersed in the silicon phase.

### CROSS-REFERENCE TO RELATED APPLICATION

This application claims priority to Japanese Patent Application No. 2019-039928 filed on Mar. 5, 2019, incorporated herein by reference in its entirety.

### BACKGROUND

### 1. Technical Field

The present disclosure relates to a negative electrode active substance material and an electricity storage device.

### 2. Description of Related Art

In related art, it is known that a Si negative electrode for a lithium ion secondary battery has a theoretical capacity of about 4,199 mAh/g, which is about 10 times higher than a theoretical capacity of a general graphite negative electrode of 372 mAh/g, and further increase in capacity and energy density is possible. On the other hand, the volume of silicon (Li_{4.4}Si) that has stored lithium ions expands to about four times the volume of the silicon before storing lithium ions. In such a silicon negative electrode, a Li storage place which is a place where the silicon reacts with Li due to the restraint pressure is partially formed, and increase in the restraint pressure or deterioration of the charge and discharge cycle may be caused to occur due to the fact that the Li reaction place grows abnormally in the direction of the restraint pressure or the like. With respect to such a problem, for example, an all-solid state lithium ion battery which includes a negative electrode using free Si particles having a specific particle diameter as a negative electrode active substance, a solid electrolyte, a positive electrode, and a restraint member for restraining the solid electrolyte and the negative electrode, and in which the restraint pressure of the restraint member is in a range of 0.1 MPa or more and 45 MPa or less has been proposed (See, for example, Japanese Unexamined Patent Application Publication No. 2018-106984 (JP 2018-106984 A)). In this all-solid state lithium ion battery, it is possible to achieve both a reduction in restraint pressure and a capacity retention rate by adjusting the particle diameter of the Si particles. In addition, a silicon material which includes a crystalline silicon phase and a crystalline silicide phase containing one or more of Fe, Co, and Ni as an active substance has been proposed (See, for example, Japanese Unexamined Patent Application Publication No. 2013-253012 (JP 2013-253012 A), Japanese Unexamined Patent Application Publication No. 2012-82125 (JP 2012-82125 A), Japanese Unexamined Patent Application Publication No. 2015-95301 (JP 2015-95301 A)). This silicon material is said to have high capacity and effective cycle characteristics.

### SUMMARY

However, in the lithium ion battery of above-described JP 2018-106984 A, although the restraint pressure can be further reduced by controlling the particle diameter of the Si powder that is the negative electrode active substance, the reduction is not yet sufficient, and it has been needed to suppress the volume change. In particular, it has been difficult to suppress the local Li reaction place, reduce the restraint pressure, improve the capacity retention rate, or the like even by controlling the particle diameter of the Si powder that is the negative electrode active substance. In addition, in the silicon materials of above-described JP 2013-253012 A, JP 2012-82125 A, and JP 2015-95301 A, it is described that the silicide phase is complexed to further suppress the expansion of the silicon phase, but the effect is not yet sufficient, and it has been needed to further suppress the volume change. For example, in an all-solid state lithium ion battery, by applying the restraint pressure to a laminate of a positive electrode, a negative electrode, and a solid electrolyte layer, contact between active substance particles and a solid electrolyte is maintained, and battery performance may be improved. In a case when the restraint pressure is increased, the restraint member becomes large and the energy density of the entire battery decreases, and thus it is desired that the restraint pressure is decreased and the size of the restraint member is reduced. However, when the restraint pressure is decreased, the battery capacity retention rate of the battery performance decreases. Therefore, it has been an issue to achieve both a decrease in the restraint pressure and an improvement in the battery capacity.

The present disclosure has been made in consideration of such a problem, and a main object of the present disclosure is to provide a novel negative electrode active substance material and an electricity storage device that can further decrease the restraint pressure and increase the capacity.

After diligent studies to solve the above-mentioned problems, the present inventors have found that a powder obtained by melting and pulverizing a mixture in which a specific element is added to Si in a eutectic or a hypoeutectic composition is able to further suppress the volume change and further increase the capacity, and the present disclosure has been completed.

A first aspect of the present disclosure relates to a negative electrode active substance material used for an electricity storage device. The negative electrode active substance material used for an electricity storage device includes a silicon phase and a silicide phase represented by a basic composition formula MSi₂, where M is one or more of Cr, Ti, Zr, Nb, Mo, and Hf. The negative electrode active substance material has a structure in which the silicide phase is dispersed in the silicon phase.

A second aspect of the present disclosure relates to an electricity storage device including a positive electrode, a negative electrode including the negative electrode active substance material described above, and an ion conduction medium interposed between the positive electrode and the negative electrode for conducting ions.

According to the present disclosure, it is possible to provide a novel negative electrode active substance material and an electricity storage device that further reduces the restraint pressure and increases the capacity. The reason why such effects are obtained is presumed as follows. For example, by dispersing a silicide phase in a silicon phase to have a framework structure, the Li storage place in the silicon negative electrode can be made uniform, and the volume change can be further suppressed. In particular, this effect is limited in a silicide phase that contains Fe or the like, but it is presumed that the effect is higher in a silicide phase that is represented by a basic composition formula MSi₂ and that contains Cr, Ti, Zr, Nb, Mo, and Hf. It is also presumed that the capacity is further improved by having such a two-phase structure. With such a structure, it is possible to provide a novel negative electrode active substance material capable of reducing the restraint pressure, improving the capacity retention rate in a charge and discharge cycle, and improving the charge and discharge capacity or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating one example of an all-solid state type lithium ion secondary battery 10;

FIG. 2 is an equilibrium state graph of a Cr—Si binary system;

FIG. 3 is an equilibrium state graph of a Ni—Si binary system;

FIG. 4 shows cross-sectional images obtained by an SEM and an EDX analysis result of a Si-10 mol % Cr powder of Experimental Example 1;

FIG. 5 shows cross-sectional images obtained by an SEM and EDX analysis result of a Si-10 mol % Ni powder of Experimental Example 15;

FIG. 6A is a graph showing a measurement result of restraint pressure variation in charge and discharge of the initial five cycles in Experimental Example 15;

FIG. 6B is a graph showing a measurement result of restraint pressure variation in charge and discharge of the initial five cycles in Experimental Example 1;

FIG. 7 is a graph showing restraint pressure variations of the first and the second cycle in Experimental Examples 1, 4, 5, 14, and 15; and

FIG. 8 is a graph showing a measurement result of the discharge capacity of the initial five cycles in Experimental Examples 1, 4, 5, 14, and 15.

### DETAILED DESCRIPTION OF EMBODIMENTS

Negative Electrode Active Substance Material

A negative electrode active substance material of the present disclosure is used for an electricity storage device. The negative electrode active substance material used for an electricity storage device includes a silicon phase and a silicide phase represented by a basic composition formula MSi₂, where M is one or more of Cr, Ti, Zr, Nb, Mo, and Hf. The negative electrode active substance material may have a structure in which the silicide phase is dispersed in the silicon phase. In the negative electrode active substance material, the element M may be a eutectic composition or a hypoeutectic composition of the silicon phase and the silicide phase. Such a composition is preferable since a structure in which a silicon phase and a silicide phase are dispersed can be easily obtained. The element M is preferably included in a range of 2 mol % or more and 25 mol % or less with respect to an entirety of the silicon phase and the silicide phase. The content of the element M is preferably in this range since the restraint pressure can be further reduced and the capacity can be increased. The content of the element M is more preferably 5 mol % or more and may be 7 mol % or more. In addition, the content of the element M is preferably 15 mol % or less and may be 12 mol % or less.

In the negative electrode active substance material of the present disclosure, the silicide phase preferably contains two or more elements M. It is preferable to include two or more silicide phases since the restraint pressure can be further reduced and the capacity can be increased. In particular, the silicide phase preferably contains at least Zr as the element M and further contains one or more of Cr and Hf. This combination can further reduce the restraint pressure and increase the capacity. In this case, Zr is preferably included in a range of 5 mol % or more and 10 mol % or less with respect to the entirety of the silicon phase and the silicide phase and that one or more of Cr and Hf is preferably included in a range of 5 mol % or more and 15 mol % or less with respect to the entirety of the silicon phase and the silicide phase.

In the negative electrode active substance material of the present disclosure, the volume proportion of the silicide phase is preferably in a range of 5% by volume to 90% by volume and more preferably in a range of 10% by volume to 50% by volume with respect to the entirety of the silicon phase and the silicide phase. The volume proportion can be determined by performing elemental analysis of the material and using the principle of leverage in a state graph from the obtained ratio of the elements.

Method for Producing Negative Electrode Active Substance Material

Next, a method for producing a negative electrode active substance material will be described. In this producing method, predetermined amounts of a lumpy Si raw material and a lumpy element M raw material (metal lump) forming a silicide phase are weighed, an ingot is prepared by argon arc melting (about 1,500° C.), the prepared ingot is crushed, and then a silicon alloy powder can be obtained. The element M can be, for example, one or more of Cr, Ti, Zr, Nb, Mo, and Hf. The blending ratio of the raw material is preferably, for example, in a range in which the element M is a eutectic composition or a hypoeutectic composition of the silicon phase and the silicide phase. In addition, the blending ratio of the raw materials is preferably in a range in which the element M is 2 mol % or more and 25 mol % or less with respect to the entirety of the silicon phase and the silicide phase. The ingot can be pulverized with, for example, a ball mill. The particle size of the silicon alloy may be, for example, in a range in which an average particle diameter is 20 μm or more and 50 μm or less. The powdery silicon alloy obtained in this manner can be used as a negative electrode active substance material.

Electricity Storage Device

The electricity storage device of the present disclosure includes a positive electrode, a negative electrode including the negative electrode active substance material described above, and an ion conduction medium interposed between the positive electrode and the negative electrode for conducting ions. The electricity storage device may be a secondary battery using alkali metal ions as a carrier. Examples of the alkali metals include lithium, sodium, and potassium, and among these, lithium is preferable. In addition, examples of the electricity storage devices include an alkali metal ion secondary battery, a hybrid capacitor, and an air battery. Here, a lithium ion secondary battery will be mainly described. Since the lithium ion secondary battery further suppresses the volume change in the negative electrode active substance material, it is more preferable that the lithium ion secondary battery is an all-solid state lithium ion secondary battery in which an ion conduction medium is a solid electrolyte. In the all-solid state lithium secondary battery, it is known that the contactability between the positive electrode and the solid electrolyte interface, and the contactability between the negative electrode and the solid electrolyte interface greatly affect the battery performance, and thus it is highly significant to use the negative electrode active substance material of the present disclosure that has a small restraint pressure variation for the all-solid state battery.

The positive electrode may be formed by, for example, mixing a positive electrode active substance and as necessary, a conductive material, a binder, a solid electrolyte, and the like, adding a suitable solvent to form a paste-like positive electrode mixture, coating the positive electrode mixture on the surface of a current collector, drying the coated surface, and as necessary, compressing to increase the electrode density. As the positive electrode active substance, a sulfide containing a transition metal element, an oxide containing lithium and a transition metal element, or the like can be used. Specifically, transition metal sulfides such as TiS₂, TiS₃, MoS₃, and FeS₂, a lithium-manganese complex oxide having a basic composition formula of Li₍₁₋ₓ₎MnO₂ (0<x<1, the same applies hereinafter), Li₍₁₋ₓ₎Mn₂O₄, or the like, a lithium-cobalt complex oxide having a basic composition formula of Li₍₁₋ₓ₎CoO₂ or the like, a lithium-nickel complex oxide having a basic composition formula of Li₍₁₋ₓ₎NiO₂ or the like, a lithium-nickel-cobalt-manganese complex oxide having a basic composition formula of Li₍₁₋ₓ₎NiₐCo_{b}Mn_{c}O₂ (a+b+c=1), Li₍₁₋ₓ₎NiₐCo_{b}Mn_{c}O₄ (a+b+c=2), or the like, or the like can be used. Among these, a transition metal complex oxide of lithium, for example, LiNi_{1/3}Co_{1/3}Mn_{1/3}O₂ is preferable. The “basic composition formula” is intended to include other elements.

The conductive material is not particularly limited as long as it is an electron conductive material that does not adversely affect the battery performance of the positive electrode. For example, graphite such as a natural graphite (a scaly graphite, a scaly flaky graphite) and an artificial graphite, acetylene black, carbon black, Ketjen black, carbon whisker, needle coke, carbon fiber, a metal (copper, nickel, aluminum, silver, gold, or the like), and the like can be used alone or a mixture of two or more thereof can be used. Among these, carbon black and acetylene black are preferable as the conductive material from the viewpoints of electron conductivity and coatability. The binder plays a role in binding the active substance particles and the conductive material particles. For example, fluorine-containing resins such as polytetrafluoroethylene (PTFE), polyvinylidene fluoride (PVDF), and fluororubber, or thermoplastic resins such as polypropylene and polyethylene, an ethylene propylene diene rubber (EPDM), a sulfonated EPDM rubber, a natural butyl rubber (NBR), and the like can be used alone or as a mixture of two or more thereof. In addition, an aqueous dispersion of a cellulose-based binder which is an aqueous binder or a styrene butadiene rubber (SBR) can also be used. As the solvents in which the positive electrode active substance, the conductive material, and the binder are dispersed, organic solvents such as include N-methylpyrrolidone, dimethylformamide, dimethylacetamide, methylethylketone, cyclohexanone, methyl acetate, methyl acrylate, diethylenetriamine, N,N-dimethylaminopropylamine, ethylene oxide, and tetrahydrofuran can be used. In addition, a dispersant, a thickener, or the like may be added to water, and the active substance may be slurried with a latex such as SBR. As the thickener, for example, polysaccharides such as carboxymethyl cellulose and methylcellulose can be used alone or as a mixture of two or more thereof. Examples of the coating method include roller coating such as an applicator roll, screen coating, a doctor blade method, spin coating, and a bar coater. Any of these can be used to obtain a suitable thickness and shape. Examples of the current collector include stainless steel, Ni, Cr, Au, Pt, Al, Fe, Ti, and Zn. The current collector may be a current collector obtained by plating and depositing Ni, Cr, C, or the like on a metal foil. Examples of the shape of the current collector include a foil shape, a film shape, a sheet shape, a net shape, a punched or expanded shape, a lathed shape, a porous shape, a foamed shape, and a formed body of fibers. The thickness of the current collector is, for example, 1 μm to 500 μm.

The negative electrode may include the current collector and a negative electrode active substance layer provided adjacent to the current collector. The negative electrode active substance layer may include the conductive material, the binder, the solid electrolyte, and the like in addition to the negative electrode active substance material described above. The active substance layer of the negative electrode is similar to the positive electrode, and preferably contains more active substance particles, and may contain the active substance particles in a range of 60% by volume or more and 98% by volume or less. The negative electrode may be formed by bringing the negative electrode active substance and the current collector into close contact with each other. For example, the negative electrode may be formed by mixing a negative electrode active substance, a conductive material, and a binder, adding a suitable solvent to form a paste-like negative electrode mixture, coating the negative electrode mixture on the surface of a current collector, drying the coated surface, and as necessary, compressing to increase the electrode density. In addition, as the conductive material, the binder, the solvent, and the like used for the negative electrode, those exemplified for the positive electrode can be used. Examples of the current collector of the negative electrode include Cu, stainless steel, Ni, Cr, Au, Pt, Al, Fe, Ti, Zn, calcinated carbon, a conductive polymer, and a conductive glass. The shape of the current collector may be the same as that of the positive electrode.

In the electricity storage device, examples of the solid electrolytes include an inorganic solid electrolyte and a polymer solid electrolyte. The solid electrolyte is not limited to the following composition and structure, and any solid electrolyte may be used as long as Li ions can migrate. A solid electrolyte partially substituted or having a different compositional ratio can be used as long as the solid electrolyte is a compound having a basic skeleton exemplified below. Examples of the inorganic solid electrolytes include Li₃N, Li₁₄Zn(GeO₄)₄ called LISICON, a sulfide Li_{3.25}Ge_{0.25}P_{0.75}S₄, a perovskite type La_{0.5}Li_{0.5}TiO₃, (La_{2/3}Li₃ₓA_{1/3-2x})TiO₃ (A: atomic vacancy), a garnet type Li₇La₃Zr₂O₁₂, LiTi₂(PO₄)₃ and Li_{1.3}M_{0.3}Ti_{1.7}(PO₃)₄ (M=Sc, Al) that are called a NASICON type, Li₇P₃S₁₁ obtained from glass having a composition of a glass ceramic 80Li₂S.20P₂S₅ (mol %), Li₁₀Ge₂PS₂ that is a sulfide-based material having a high conductivity, a glass-based inorganic solid electrolyte such as Li₂S—SiS₂, Li₂S—SiS₂—LiI, Li₂S—SiS₂—Li₃PO₄, Li₂S—SiS₂—Li₄SiO₄, Li₂S—P₂S₅, Li₃PO₄—Li₄SiO₄, and Li₃BO₄—Li₄SiO₄, and an electrolyte including SiO₂, GeO₂, B₂O₃, or P₂O₅ as a glass-based material and Li₂O as a network modifying material. Examples of thio-LISICON solid electrolytes include a Li₂S—GeS₂-based electrolyte, a Li₂S—GeS₂—ZnS-based electrolyte, a Li₂S—Ga₂S₂-based electrolyte, a Li₂S—GeS₂—Ga₂S₃-based electrolyte, a Li₂S—GeS₂—P₂S₅-based electrolyte, a Li₂S—GeS₂—SbS₅-based electrolyte, a Li2_{S}—GeS₂—Al₂S₃-based electrolyte, a Li₂S—SiS₂-based electrolyte, a Li₂S—P₂S₅-based electrolyte, a Li₂S—Al₂S₃-based electrolyte, a LiS—SiS₂—Al₂S₃-based electrolyte, and a Li₂S—SiS₂—P₂S₅-based electrolyte.

Examples of the polymer solid electrolytes include a complex of polyethylene oxide (PEO) and an alkali metal, in which the polymer is not limited to PEO as long as it is a polymer. Examples of unit structures of polymer materials that dissolve a lithium salt include polyether-based structures such as PPO and poly(propylene oxide) (PEO), a polyamine-based structure such as poly(ethylene imine) (PEI), PAN: poly (acrylonitrile), and a polysulfide-based structure such as poly(alkylene sulfide) (PAS). Examples of lithium salts include LiTFSI:(LiN(SO₂CF₃)₂), LiPEI:(COCF₂SO₂NLi)ₙ, and LiPPI:(COCF(CF₃OCF₂CF₂SO₂NLi))ₙ. In addition, a gel polymer electrolyte using polyvinylidene difluoride (PVdF), PAN, hexafluoropropylene (HFP), or the like may be mentioned. Further, as an organic ionic plastic electrolyte, an electrolyte having a plastic crystal phase may be mentioned. Examples of representative molecules of the plastic crystal phases include tetrachloromethane, cyclohexane, and succinonitrile. Trifluoromethylsulfonylamide (Tf₂N) and LiBF₄ may be added to these plastic crystal phases, or a combination of salts having a plastic crystal phase formed of an aliphatic quaternary ammonium and a perfluoroanion may be used. An organic and inorganic hybrid ion gel in which an ionic liquid and a glass component are mixed at the molecular level, that is, an organic boron-based ion gel electrolyte using cellulose, an organic boron-based ion gel electrolyte using amylose, and a multiple borons-substituted macrocycle derived from cyclodextrin, and the like may be mentioned.

The ion conduction medium may be a general non-aqueous electrolyte containing a supporting salt, a non-aqueous gel electrolyte, or the like. As the solvent for the non-aqueous electrolyte, a carbonate an ester, an ether, a nitrile, a furan, a sulfolane, a dioxolane, and the like are mentioned, and these can be used alone or as a mixture. Examples of the supporting salts include LiPF₆, LiBF₄, LiAsF₆, LiCF₃SO₃, LiN(CF₃SO₂)₂, LiC(CF₃SO₂)₃, LiSbF₆, LiSiF₆, LiAlF₄, LiSCN, LiClO₄, LiCl, LiF, LiBr, LiI, and LiAlCl₄. Among these, one or more of salts selected from the group consisting of inorganic salts such as LiPF₆, LiBF₄, LiAsF₆, and LiClO₄, and organic salts such as LiCF₃SO₃, LiN(CF₃SO₂)₂, and LiC(CF₃SO₂)₃ are preferably combined to be used from the viewpoint of electrical characteristics. The concentration of the supporting salt in the non-aqueous electrolyte is preferably 0.1 mol/L or more and 5 mol/L or less, and more preferably 0.5 mol/L or more and 2 mol/L or less. In a case where the concentration for dissolving the supporting salt is 0.1 mol/L or more, a sufficient current density can be obtained, and in a case where the concentration is 5 mol/L or less, the electrolyte can be further stabilized. In addition, a flame retardant such as a phosphorus-based retardant or a halogen-based retardant may be added to the non-aqueous electrolyte.

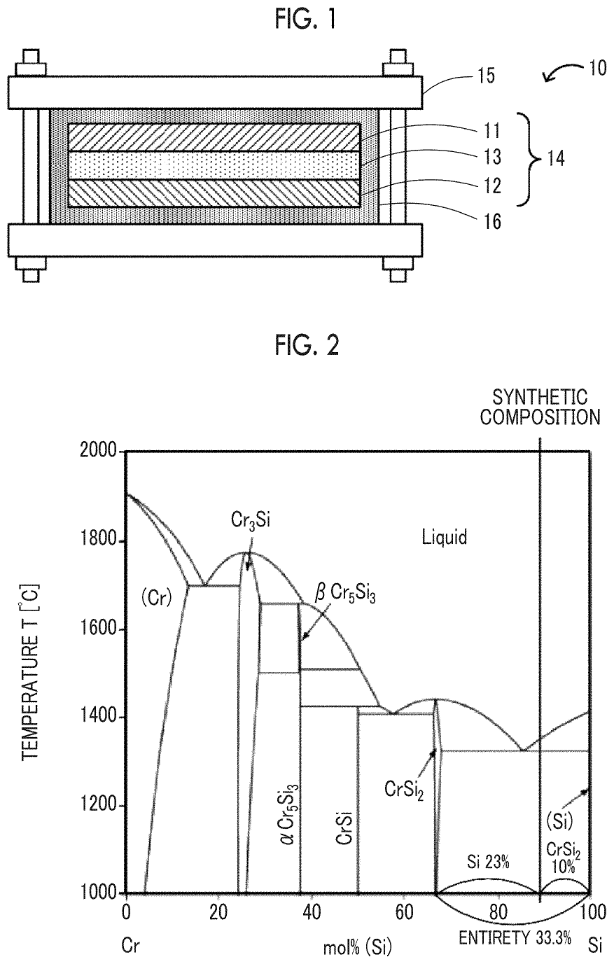

The shape of the electricity storage device is not particularly limited, and examples thereof include a coin type, a button type, a sheet type, a laminated type, a cylindrical type, a flat type, and a square type. In addition, a plurality of such batteries may be connected in series and applied to a large battery used for an electric vehicle or the like. The structure of the electricity storage device is not particularly limited, but, for example, the structure shown in FIG. 1 may be mentioned. FIG. 1 is an explanatory diagram illustrating one example of the structure of an all-solid state type lithium ion secondary battery 10. The all-solid state lithium ion secondary battery 10 includes a positive electrode 11 including a positive electrode active substance, a negative electrode 12 including a negative electrode active substance material, a solid electrolyte layer 13, and a laminate 14 formed of the positive electrode 11, the negative electrode 12, and the solid electrolyte layer 13. The all-solid state lithium ion secondary battery 10 includes a restraint member 15 restraining the laminate 14 and a battery case 16 containing the laminate 14. In the all-solid state lithium ion secondary battery 10, the volume change of the negative electrode active substance material is further suppressed, and then the restraint pressure can be further reduced.

As described above in detail, according to the present disclosure, it is possible to provide a novel negative electrode active substance material and an electricity storage device that further reduces the restraint pressure and increases the capacity. The reason why such effects are obtained is presumed as follows. For example, by dispersing a silicide phase in a silicon phase to have a framework structure, the Li storage place in the silicon negative electrode can be made uniform, and the volume change can be further suppressed. In particular, this effect is limited in a silicide phase that contains Fe or the like, but it is presumed that the effect is higher in a silicide phase that is represented by a basic composition formula MSi₂ and that contains Cr, Ti, Zr, Nb, Mo, and Hf. It is also presumed that the capacity is further improved by having such a two-phase structure. With such a structure, it is possible to provide a novel negative electrode active substance material capable of reducing the restraint pressure, improving the capacity retention rate in a charge and discharge cycle, and improving the charge and discharge capacity or the like.

The present disclosure is not limited to the above-described embodiments at all, and the present disclosure can be implemented in various aspects as long as the aspect belongs to the technical scope of the present disclosure.

### EXAMPLES

Hereinafter, examples in which the negative electrode active substance materials of the present disclosure are specifically produced will be described as Experimental Examples. Experimental Examples 1 to 13 correspond to Example of the present disclosure, and Experimental Examples 14 and 15 correspond to Comparative Example.

Preparation of Positive Electrode

Butyl butyrate, a butyl butyrate solution containing 5% by mass of a PVdF-based binder, LiNi_{1/3}Co_{1/3}Mn_{1/3}O₂ particles having a particle diameter of 6 μm as a positive electrode active substance, a glass ceramic including Li₂S—P₂S₅ as a solid electrolyte, and a vapor-grown carbon fiber (VGCF) as a conductive auxiliary agent were added in a polypropylene container, and then the mixture was stirred for 30 seconds with an ultrasonic dispersion apparatus (UH-50 manufactured by SMT CO., LTD.). Next, the container was shaken with a shaker (TTM-1 manufactured by SHIBATA SCIENTIFIC TECHNOLOGY LTD.) for 3 minutes and further stirred with an ultrasonic dispersion apparatus for 30 seconds. Thereafter, the container was further shaken for 3 minutes with the shaker to obtain a slurry. The slurry was applied on an aluminum foil (manufactured by Showa Denko K.K.) by a blade method using an applicator. Thereafter, a positive electrode having a positive electrode mixture layer (thickness of about 50 μm) on the aluminum foil was obtained by drying on a hot plate at 100° C. for 30 minutes.

Preparation of Negative Electrode

For a negative electrode active substance Si alloy, a silicon alloy ingot was prepared by blending a predetermined amount of silicon manufactured by Kojundo Chemical Lab. Co., Ltd. and an element M, and performing argon arc melting. The ingot was crushed with a tungsten mortar, and a silicon alloy powder was prepared by a ball mill. The particle size was adjusted from the obtained Si alloy powder and was measured using a particle size distribution measuring apparatus (Scirocco 2,000 manufactured by Malvern Panalytical Ltd.) based on a laser diffraction and light scattering method, and the resultant was used as a negative electrode active substance. The average particle diameter (D50) of the Si alloy particles contained in the negative electrode is 5 μm to 15 μm, D10 is 1 μm to 2 μm, and D90 is 10 μm to 20 μm. In the measured volume-based particle size distribution, the particle diameter corresponding to a cumulative 10% by volume from the fine particle side was set as D10, the particle diameter corresponding to a cumulative 50% by volume was set as D50, and the particle diameter corresponding to 90% by volume cumulative was set as D90. Butyl butyrate, a butyl butyrate solution containing 5% by mass of a PVdF-based binder, free Si particles having a different average particle diameter or a Si alloy powder as a negative electrode active substance, and a glass ceramic including Li₂S—P₂S₅ as a solid electrolyte were added in a polypropylene container, and then the mixture was stirred for 30 seconds with an ultrasonic dispersion apparatus (UH-50 manufactured by SMT CO., LTD.). Next, the container was shaken with a shaker (TTM-1 manufactured by SHIBATA SCIENTIFIC TECHNOLOGY LTD.) for 30 seconds to obtain a slurry. The slurry was applied on a copper foil by a blade method using an applicator. Thereafter, a negative electrode having a negative electrode mixture layer (thickness of about 30 μm) on the copper foil was obtained by drying on a hot plate at 100° C. for 30 minutes.

Preparation of Solid Electrolyte Layer

Li₂S (manufactured by Nippon Chemical Industry CO., LTD.) and P₂S₅ (manufactured by Sigma-Aldrich Co. LLC) were used as starting materials, weighed so that the molar ratio was Li₂S:P₂S₅=3:1, and mixed using an agate mortar. Thereafter, the mixture and heptane were put into a container, and mechanical milling was performed using a planetary ball mill for 40 hours to obtain a Li₂S—P₂S₅-based solid electrolyte. Heptane, a heptane solution containing 5% by mass of a butadiene rubber (BR) binder, and a glass ceramic including LiI—LiBr—Li₂S—P₂S₅ as a solid electrolyte were added in a polypropylene container, and then the mixture was stirred for 30 seconds with an ultrasonic dispersion apparatus (UH-50 manufactured by SMT CO., LTD.). Next, the container was shaken with a shaker (TTM-1 manufactured by SHIBATA SCIENTIFIC TECHNOLOGY LTD.) for 30 seconds to obtain a slurry. The slurry was applied on a base material (aluminum foil) by a blade method using an applicator. Thereafter, a solid electrolyte layer (thickness of about 15 μm) was formed on the base material by drying on a hot plate at 100° C. for 30 minutes.

Preparation of All-Solid State Lithium Ion Battery

The solid electrolyte layer and the positive electrode were laminated so that the solid electrolyte layer was in contact with the positive electrode mixture layer, and pressed at 1 ton/cm². Thereafter, the base material was peeled off to obtain a two-layer body including the solid electrolyte layer and the positive electrode. Next, the two-layer body and the negative electrode were laminated so that the solid electrolyte layer of the two-layer body was in contact with the negative electrode mixture layer, and pressed at 6 ton/cm² to obtain a laminate having the solid electrolyte between the positive electrode and the negative electrode. The obtained laminate (cell) was restrained at a predetermined restraint pressure (1.4 MPa) using a screw-fastening type restraint member (see FIG. 1) to obtain an all-solid state lithium ion battery for evaluation.

### Experimental Examples 1 to 3

A predetermined amount of a lumpy Cr raw material of 2 mm to 5 mm manufactured by Kojundo Chemical Lab. Co., Ltd. was mixed with a lumpy Si raw material of 2 mm to 5 mm manufactured by Kojundo Chemical Lab. Co., Ltd., and an ingot was prepared by argon arc melting (about 1,500° C.). The ingot was crushed with a tungsten mortar, and a silicon alloy powder was prepared by a ball mill and used as a Si alloy active substance for a negative electrode. Si alloy active substances for a negative electrode in which the content of Cr was 10 mol %, 5 mol %, and 14 mol % were respectively set as Experimental Examples 1 to 3.

### Experimental Example 4

A Si alloy active substance for a negative electrode obtained through the same process as in Experimental Example 1, except that a sponge-like Ti raw material of 2 mm to 5 mm manufactured by Kojundo Chemical Lab. Co., Ltd. was mixed as a raw material so that the Ti content was 14 mol %, was set as Experimental Example 4.

### Experimental Examples 5 and 6

Si alloy active substances for a negative electrode obtained through the same process as in Experimental Example 1, except that a linear Zr raw material having a diameter of 1 mm and a length of about 20 mm manufactured by Nilaco Corporation was mixed as a raw material so that Zr content was 5 mol % and 9 mol %, were respectively set as Experimental Examples 5 and 6.

### Experimental Examples 7 and 8

Si alloy active substances for a negative electrode obtained through the same process as in Experimental Example 1, except that a lumpy Nb raw material of 2 mm to 5 mm manufactured by Kojundo Chemical Lab. Co., Ltd. was mixed as a raw material so that the Nb content was 5 mol %, was set as Experimental Example 7. A Si alloy active substance for a negative electrode obtained through the same process as in Experimental Example 1, except that a lumpy Mo raw material of 1 mm to 5 mm manufactured by Kojundo Chemical Lab. Co., Ltd. was mixed as a raw material so that the Mo content was 5 mol %, was set as Experimental Example 8.

### Experimental Examples 9 and 10

Si alloy active substances for a negative electrode obtained through the same process as in Experimental Example 1, except that a sponge-like Hf raw material of 5 mm to 10 mm manufactured by Kojundo Chemical Lab. Co., Ltd. was mixed as a raw material so that the Hf content was 5 mol % and 11 mol %, were respectively set as Experimental Examples 9 and 10.

### Experimental Examples 11 to 13

A Si alloy active substance for a negative electrode obtained through the same process as in Experimental Example 1, except that a lumpy Cr raw material of 2 mm to 5 mm and a sponge-like Hf raw material of 2 mm to 5 mm manufactured by Kojundo Chemical Lab. Co., Ltd. were mixed as raw materials so that the Cr content was 7 mol % and the Zr content was 7 mol %, was set as Experimental Example 11. A Si alloy active substance for a negative electrode obtained through the same process as in Experimental Example 1, except that a sponge-like Hf raw material of 5 mm to 10 mm manufactured by Kojundo Chemical Lab. Co., Ltd. and a linear Zr raw material having a diameter of 1 mm and a length of 20 mm manufactured by Nilaco Corporation were mixed as raw materials so that the Hf content was 6 mol % and the Zr content was 4 mol %, was set as Experimental Example 12. A Si alloy active substance for a negative electrode obtained through the same process as in Experimental Example 1, except that a lumpy Cr raw material of 1.7 mm to 4 mm manufactured by Kojundo Chemical Lab. Co., Ltd. and a linear Zr raw material having a diameter of 1 mm and a length of 10 mm manufactured by Nilaco Corporation were mixed as raw materials so that the Cr content was 13 mol % and the Zr content was 9 mol %, was set as Experimental Example 13.

### Experimental Example 14

Experimental Example 14 used Si particles having an average particle diameter of about 1 μm to 5 μm as a Si alloy active substance for a negative electrode.

### Experimental Example 15

A Si alloy active substance for a negative electrode obtained through the same process as in Experimental Example 1, except that a lumpy Ni raw material of 2 mm to 5 mm manufactured by Kojundo Chemical Lab. Co., Ltd. was mixed as a raw material so that the Ni content was 10 mol %, was set as Experimental Example 15.

SEM Observation and Elemental Analysis

The obtained negative electrode active substance was subjected to an element mapping by a scanning electron microscope (SEM) observation and an EDX analysis to observe the distribution state of the elements. For the SEM observation and the element mapping, a scanning electron microscope (S-3600N manufactured by Hitachi, Ltd.) and an energy dispersive X-ray analyzer (EDAX) were used. The acceleration voltage was set to 15 kV.

Volume Ratio of Silicide Phase

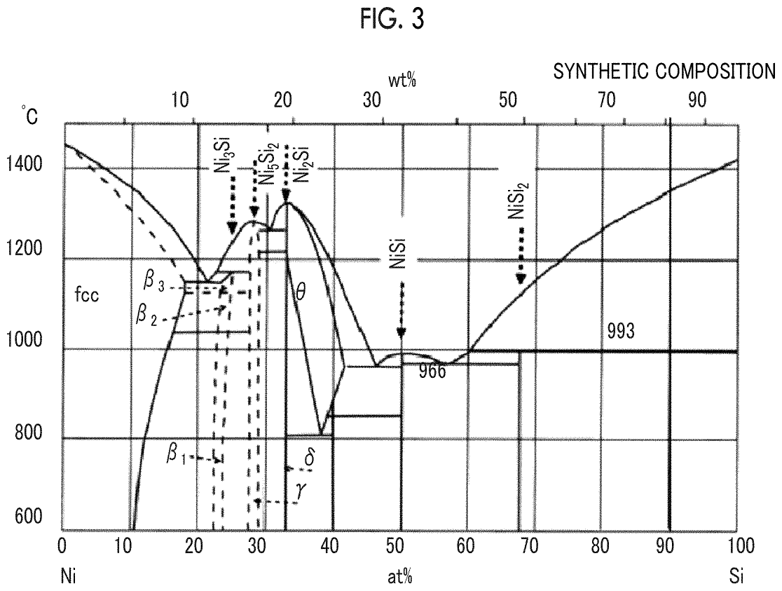

From the blended compositional ratio, the volume proportion of the silicide phase was determined using the principle of leverage in a state graph (see FIG. 2). For example, in Experimental Example 1 which contains 10 mol of Cr, the silicide phase accounts for 10% of the entire 33.3%, and thus the volume ratio can be determined to be 10/33.3×100=30% by volume. It is noted that the volume proportion of the silicide phase can also be determined by calculating an area of the silicon phase and an area of the silicide phase in an SEM photograph and by setting the area ratio thereof as the volume proportion.

Performance Evaluation of All-Solid State Lithium Ion Battery

Preliminary charge and discharge were performed at a rate of 0.1 C to 1 C at a potential of 3.0 V to 4.55 V with an initial restraint pressure of 1.25 MPa. Furthermore, charge and discharge were performed in the initial five cycles under the following conditions, the capacity was confirmed, and the restraint pressure variation was calculated. First, as a preliminary charge, the battery was charged at constant current and constant voltage up to 4.55 V at a time rate of 0.1 C. Next, as a preliminary discharge, the battery was discharged to 3.0 V at constant current and constant voltage at a time rate of 1 C. Subsequently, as the first to the fifth charge, the battery was charged up to 4.35 V at constant current and constant voltage at a time rate of 0.33 C. In addition, as the first to the fifth discharge, the battery was discharged to 3.0 V at constant current and constant voltage at a time rate of 0.33 C. Then, the restraint pressure variation and the capacity were calculated based on the charge and discharge results. In the above charge and discharge, the restraint pressure variations (MPa) of the first and the second cycle were determined, and the discharge capacities (mAh) and the capacity retention rates (%) of the first and the fifth cycle were determined.

Measurement of Restraint Pressure Variation

Variations in the restraint pressure of the cells of Experimental Examples 1 to 15 were measured. During the above-described charge and discharge cycle, a pressure sensor (a small-sized compression load cell manufactured by Kyowa Electronic Instruments Co., Ltd.) was inserted between the restraint member and the battery case, and the pressure was measured at predetermined time intervals.

Examination of Si Alloy Composition for Negative Electrode

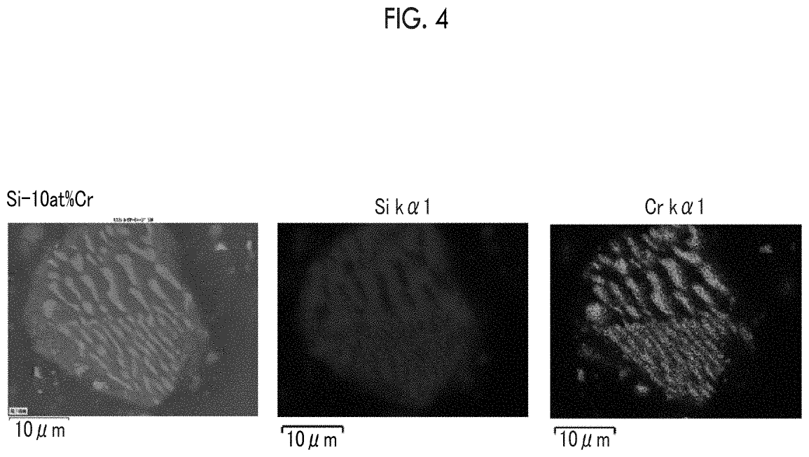

FIG. 2 is an equilibrium state graph of a Cr—Si binary system. FIG. 3 is an equilibrium state graph of a Ni—Si binary system. From the state graph of a Cr—Si binary system shown in FIG. 2, a lamellar structure of Si and CrSi₂ is formed by a eutectic reaction between Si and CrSi₂ from the liquid phase in the composition of Si-14 mol % Cr. From the state graph of a Ni—Si binary system shown in FIG. 3, a lamellar structure of Si and NiSi is formed by a eutectic reaction between Si and SiNi from the liquid phase in the composition of Si-56 mol % Ni although the NiSi₂ silicide phase exists. Based on the above-described relationship, a Si raw material was mixed with a 10 mol % Cr raw material and a Ni raw material, and an ingot was produced by argon arc melting. The Si-10 mol % Cr of Experimental Example 1 had a hypoeutectic composition of Si and CrSi₂, while the Si-10 mol % Ni of Experimental Example 15 had a hypoeutectic composition of Si and NiSi.

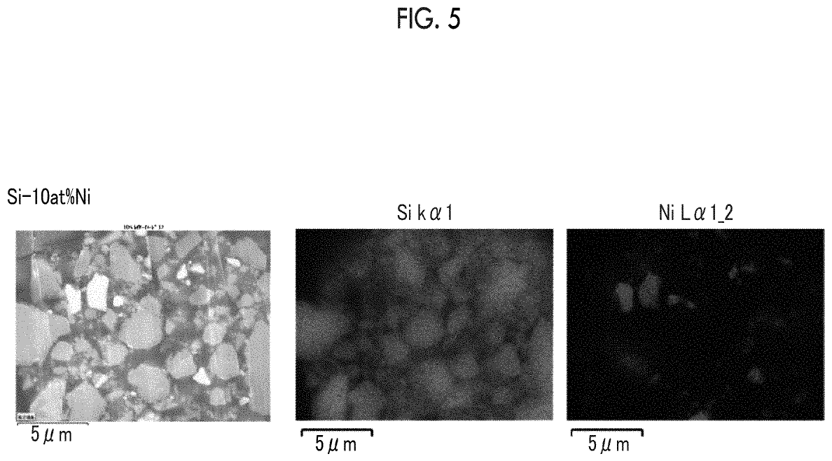

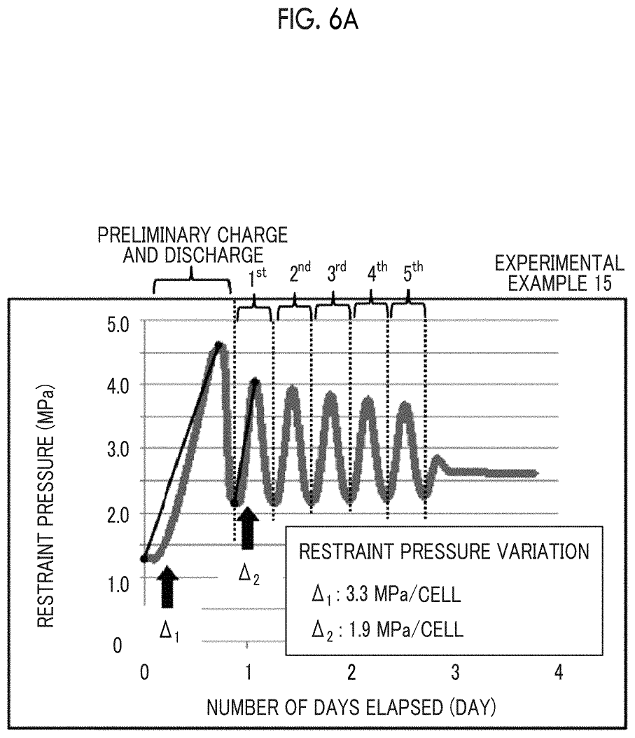

FIG. 4 shows cross-sectional images obtained by an SEM and an EDX analysis result of a Si-10 mol % Cr powder of Experimental Example 1. FIG. 5 shows cross-sectional images obtained by an SEM and an EDX analysis result of a Si-10 mol % Ni powder of Experimental Example 15. As shown in FIG. 4, it was found that the Si-10 mol % Cr powder of Experimental Example 1 has a structure in which CrSi₂ is dispersed in the Si framework structure. On the other hand, as shown in FIG. 5, in the Si-10 mol % Ni powder of Experimental Example 15, it was found that the Si compound and the Ni compound are separated.

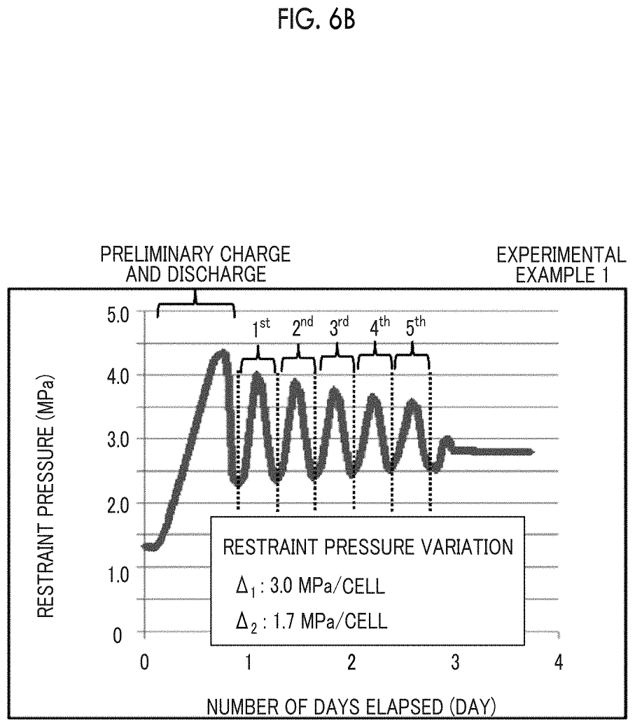

FIGS. 6A and 6B are graphs showing measurement results of restraint pressure variation in charge and discharge of the initial five cycles, FIG. 6A is the measurement result of Experimental Example 15, and FIG. 6B is the measurement result of Experimental Example 1. The measurement result of Experimental Example 14 was the same as the measurement result of Experimental Example 15. As shown in FIGS. 6A and 6B, it was found that the preliminary charge and discharge and the restraint pressure variation of the second cycle are respectively 3.3 MPa and 1.9 MPa in Experimental Example 15, and respectively 3.0 MPa and 1.7 MPa in Experimental Example 1, and that the effect of the above-described structure is obtained and the restraint pressure variation is reduced.

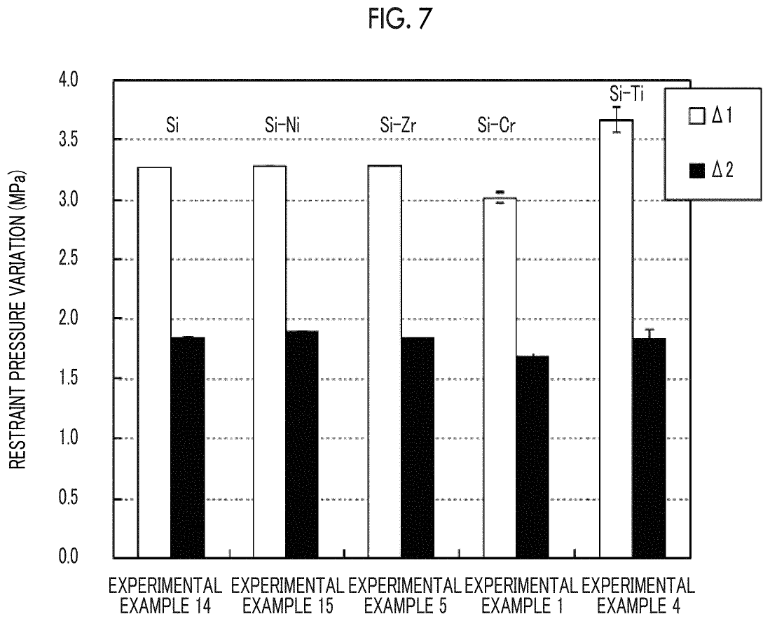

Next, the measurement results of Experimental Examples 2 and 13 will be discussed. Table 1 collectively shows the restraint pressure variations (MPa) of the first and the second cycle and the discharge capacities (mAh) and the capacity retention rates (%) of the first and the fifth cycle in Experimental Examples 1 to 15. FIG. 7 is a graph showing the measurement results of the restraint pressure variations of the first and the second cycle in Experimental Examples 1, 4, 5, 14, and 15. As shown in FIG. 7, it was found that the restraint pressure variation at least after the second cycle was small in Experimental Examples 1, 4, and 5 in comparison with in Experimental Example 14 which was a reference. In addition, it was found that the restraint pressure variations of the first and the second cycle in Experimental Examples 7 to 10 containing Nb, Mo, Hf, or the like are respectively 2.87 MPa to 3.04 MPa and 1.56 MPa to 1.69 MPa, which are small in comparison with in Experimental Example 14, and that the same effect is obtained. On the other hand, it was found that such an effect is not obtained in Experimental Example 15 containing Ni and that the effect is specific to a specific element.

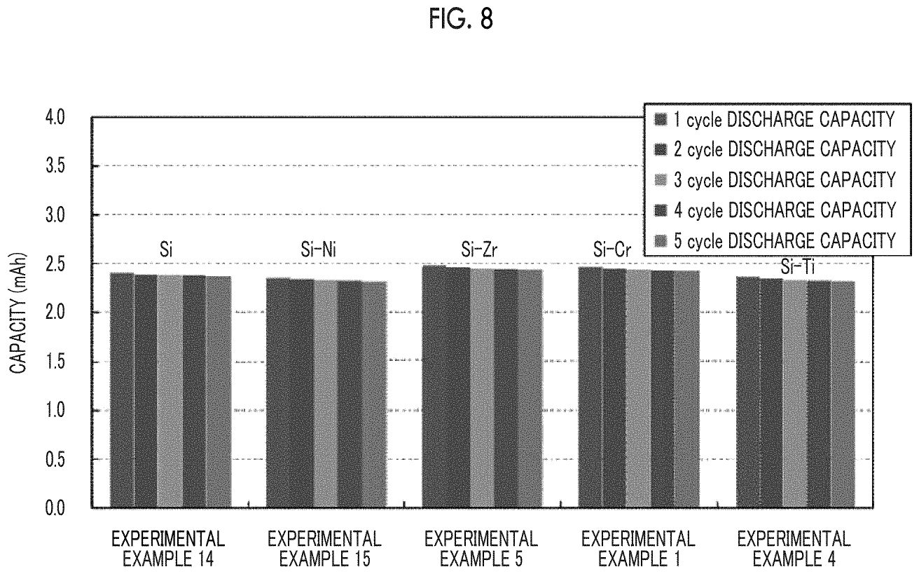

FIG. 8 is a graph showing measurement results showing the change in discharge capacity of the initial five cycles in Experimental Examples 1, 4, 5, 14, and 15. The discharge capacities of the second cycle in Experimental Examples 14 and 15 were respectively 2.39 mAh and 2.33 mAh, the discharge capacities of the fifth cycle were respectively reduced to 2.33 mAh and 2.27 mAh, and the capacity retention rates at five cycles were respectively 97.5% and 97.4%. On the other hand, the initial discharge capacity in Experimental Example 1 was 2.45 mAh and the discharge capacity at five cycles was 2.42 mAh, which were higher than those of Experimental Examples 14 and 15, and the capacity retention rate was also improved to 98.7%. As shown in Table 1, the similar results were obtained for Experimental Examples 2 to 10, the capacity retention rate at five cycles showed values of 98.3% to 98.8%, and both the discharge capacity and the capacity retention rate were improved in comparison with Experimental Example 14. On the other hand, it was found that such an effect is not obtained in Experimental Example 15 containing Ni and that the effect is specific to a specific element. It was considered that a lamellar structure was formed by a eutectic reaction between Si and MSi₂ silicide containing each of the elements M (Cr, Ti, Zr, Nb, Mo, and Hf), thereby reducing the restraint pressure variation and improving the capacity retention rate.

Further, the negative electrode active substances of Experimental Examples 11 to 13 containing a plurality of types of elements M will be discussed. It was found the restraint pressure variations of the first and the second cycle in Experimental Examples 11 to 13 are respectively 2.56 MPa to 2.76 MPa and 1.38 MPa to 1.48 MPa, which are further reduced than in Experimental Example 14 and 15. On the other hand, the capacity retention rates after five cycles in Experimental Examples 11 to 13 have values between 98.4% and 98.8%, which are higher than that in Experimental Example 14, and the capacity retention rate is improved. It was considered that a lamellar structure was formed by a eutectic reaction with complex (Cr, Ti)Si₂, (Hf, Zr)Si₂, and (Cr, Zr)Si₂ silicide which were formed of Si and respectively (Cr, Ti), (Hf, Zr), and (Cr, Zr), thereby reducing the restraint pressure variation and improving the capacity retention rate.

As described above, it was found that the negative electrode active substance material preferably includes a silicon phase and a silicide phase represented by a basic composition formula MSi₂, where M is one or more of Cr, Ti, Zr, Nb, Mo, and Hf and that the negative electrode active substance material may have a structure in which the silicide phase is dispersed in the silicon phase. In addition, it was found that the element M is preferably a eutectic composition or a hypoeutectic composition of a silicon phase and a silicide phase, preferably in a range of 2 mol % or more and 25 mol % or less, and more preferably in a range of 5 mol % or more and 15 mol % or less with respect to the entirety of the silicon phase and the silicide phase. In particular, it was found that the silicide phase containing at least Zr as the element M and further containing one or more of Cr and Hf further reduces the restraint pressure and has a preferred capacity and a preferred capacity retention rate. In this case, it was found that Zr is more preferably included in a range of 5 mol % or more and 10 mol % or less with respect to the entirety of the silicon phase and the silicide phase and that one or more of Cr and Hf is preferably included in a range of 5 mol % or more and 15 mol % or less with respect to the entirety of the silicon phase and the silicide phase.

TABLE 1

| | | Volume | Initial | Restraint | | | Capacity |
|---|---|---|---|---|---|---|---|
| | | proportion | restraint | pressure | Initial | Discharge | retention |
| | | of silicide | pressure | variation at | discharge | capacity at | rate at 5 |
| | | phase | variation | 2 cycles | capacity | 5 cycles | cycles |
| | Basic composition formula | (% by vol) | (MPa) | (MPa) | (mAh) | (mAh) | (%) |
| Experimental | Si-10 mol % Cr | 30 | 3.00 | 1.67 | 2.45 | 2.42 | 98.7 |
| Example 1 | | | | | | | |
| Experimental | Si-5 mol % Cr | 15 | 3.02 | 1.67 | 2.51 | 2.48 | 98.8 |
| Example 2 | | | | | | | |
| Experimental | Si-14 mol % Cr | 42 | 2.92 | 1.56 | 2.41 | 2.38 | 98.8 |
| Example 3 | | | | | | | |
| Experimental | Si-14 mol % Ti | 42 | 2.93 | 1.57 | 2.48 | 2.44 | 98.4 |
| Example 4 | | | | | | | |
| Experimental | Si-5 mol % Zr | 15 | 3.04 | 1.69 | 2.41 | 2.37 | 98.3 |
| Example 5 | | | | | | | |
| Experimental | Si-9 mol % Zr | 27 | 2.98 | 1.59 | 2.43 | 2.39 | 98.4 |
| Example 6 | | | | | | | |
| Experimental | Si-5 mol % Nb | 15 | 3.01 | 1.66 | 2.52 | 2.49 | 98.8 |
| Example 7 | | | | | | | |
| Experimental | Si-5 mol % Mo | 15 | 2.98 | 1.65 | 2.51 | 2.47 | 98.4 |
| Example 8 | | | | | | | |
| Experimental | Si-5 mol % Hf | 15 | 2.97 | 1.64 | 2.52 | 2.48 | 98.4 |
| Example 9 | | | | | | | |
| Experimental | Si-11 mol % Hf | 33 | 2.87 | 1.56 | 2.48 | 2.45 | 98.8 |
| Example 10 | | | | | | | |
| Experimental | Si-7 mol % Cr-7 mol % Zr | 42 | 2.76 | 1.48 | 2.53 | 2.49 | 98.4 |
| Example 11 | | | | | | | |
| Experimental | Si-6 mol % Hf-4 mol % Zr | 30 | 2.66 | 1.46 | 2.54 | 2.51 | 98.8 |
| Example 12 | | | | | | | |
| Experimental | Si-13 mol % Cr-9 mol % Zr | 66 | 2.56 | 1.38 | 2.56 | 2.52 | 98.4 |
| Example 13 | | | | | | | |
| Experimental | Si | — | 3.25 | 1.83 | 2.39 | 2.33 | 97.5 |
| Example 14 | | | | | | | |
| Experimental | Si-10 mol % Ni | — | 3.30 | 1.89 | 2.33 | 2.27 | 97.4 |
| Example 15 | | | | | | | |

The present disclosure is not limited to the above-described Examples at all, and the present disclosure can be implemented in various aspects as long as the aspect belongs to the technical scope of the present disclosure.

The present disclosure can be used in the technical field of a secondary battery.

What is claimed is:

1. A negative electrode active substance material used for an electricity storage device, the negative electrode active substance material comprising:
a silicon phase; and
a silicide phase represented by a basic composition formula MSi₂, where M is one or more of Cr, Ti, Zr, Nb, Mo, and Hf,
wherein the negative electrode active substance material has a structure in which the silicide phase is dispersed in the silicon phase.

2. The negative electrode active substance material according to claim 1, wherein the M is a eutectic composition or a hypoeutectic composition of the silicon phase and the silicide phase.

3. The negative electrode active substance material according to claim 1, wherein the M is included in a range of 2 mol % or more and 25 mol % or less with respect to an entirety of the silicon phase and the silicide phase.

4. The negative electrode active substance material according to claim 1, wherein the M is included in a range of 5 mol % or more and 15 mol % or less with respect to an entirety of the silicon phase and the silicide phase.

5. The negative electrode active substance material according to claim 1, wherein the silicide phase includes at least Zr as the M and further includes one or more of Cr and Hf.

6. The negative electrode active substance material according to claim 5, wherein:
the Zr is included in a range of 5 mol % or more and 10 mol % or less with respect to an entirety of the silicon phase and the silicide phase; and
the one or more of the Cr and the Hf is included in a range of 5 mol % or more and 15 mol % or less with respect to the entirety of the silicon phase and the silicide phase.

7. The negative electrode active substance material according to claim 1, wherein a volume proportion of the silicide phase is in a range of 5% by volume to 90% by volume with respect to an entirety of the silicon phase and the silicide phase.

8. The negative electrode active substance material according to claim 1, wherein a volume proportion of the silicide phase is in a range of 10% by volume to 50% by volume with respect to an entirety of the silicon phase and the silicide phase.

9. An electricity storage device comprising:
a positive electrode;
a negative electrode including the negative electrode active substance material according to claim 1; and
an ion conduction medium interposed between the positive electrode and the negative electrode for conducting ions.
